(19) United States
(12) Patent Application Publication
(10) Pub. No.: US 2013/0220517 A1
(43) Pub. Date: Aug. 29, 2013

(54) Method for Producing a Raw Tire Blank, Comprising a Stitching Step

(71) Applicants: Fabien Vignon, Clermont-Ferrand Cedex 9 (FR); Nicolas Chevaux, Clermont-Ferrand Cedex 9 (FR); Christophe Ougier, Clermont-Ferrand Cedex 9 (FR)

(72) Inventors: Fabien Vignon, Clermont-Ferrand Cedex 9 (FR); Nicolas Chevaux, Clermont-Ferrand Cedex 9 (FR); Christophe Ougier, Clermont-Ferrand Cedex 9 (FR)

(21) Appl. No.: 13/822,290

(22) PCT Filed: Sep. 5, 2011
(86) PCT No.: PCT/FR2011/052023

§ 371 Date: May 9, 2013

(30) Foreign Application Priority Data
Sep. 10, 2010 (FR) 1057212

(51) Int. Cl. B29D 30/28

(52) U.S. Cl. CPC B29D 30/28
USPC 156/110.1; 156/414

(57) ABSTRACT

In the method for producing a green tire blank, at least one stitching roller is applied to the blank with the use of a resilient roller support, and during each rotation of the blank, a set value of a level of pressure of application of the roller against the blank is made to vary between at least two non-zero values.

The invention relates to the production of tires for vehicles.

Conventionally, the production of a tire requires the manufacture of a green rubber blank. This blank is produced by placing various components, which may include wound-on strips or complete profiles, on a rotating drum. Each component is wound on in a circumferential direction relative to the axis of rotation of the drum and blank, and is generally associated with a stitching operation which may take place during the laying of the component or at the end of this operation. This operation consists in exerting a radial pressure on the component by means of a stitching element or roller. The purpose of this operation is to join the different products together to ensure the cohesion of the stack of successive layers, to expel the air from between the layers, and to limit bubble formation by counteracting the expansion of the gases in the material. It should be noted that the material is made of rubber, which is itself formed by a mixture of natural and synthetic rubbers, additives and oil.

The stitching operation is complicated by the need to apply an exact pressure which is sufficient to make the products cohere with each other without altering the profile of the finished blank or the blank in course of production. It is also necessary to carry out this operation over the whole width of the laid product and with allowance for the deformed shape of the blank and for the displacement of the assembly. This is because the drum which supports the blank is rotating. Additionally, some components are added by making the laying member move axially parallel to the direction of the axis of rotation of the drum in order to carry out a helical laying operation. Finally, some components are applied at a predetermined angle in order to obtain an application force perpendicular to the support.

These difficulties are intensified by the fact that the manufacture of blanks takes place at increasingly high speeds. A value of stitching pressure which is appropriate at low speed is not satisfactory at high speed, for various reasons. In the first place, the strip joining time is much shorter at high speed than at low speed. In these conditions, the compromise between time and stitching pressure changes. The stitching pressure must therefore be increased at high speed. Moreover, because of the geometrical imperfections of the blank being produced, the stitching member is subjected to increasingly strong mechanical excitation as the speed rises, causing the stitching pressure to fluctuate. This pressure must therefore be increased in response, in order to stiffen the stitching member and make it less sensitive to such excitation. Furthermore, while the level of pressure used for stitching at low speed cannot be applied at high speed, the converse is equally true. This is because the laid component is subject to damage if a pressure suitable for high speed is applied when laying takes place at low speed.

One object of the invention is to improve stitching, notably in order to enable blanks to be produced at high speed.

For this purpose, a method is proposed according to the invention for producing a green tire blank, in which:
at least one stitching roller is applied to the blank with the use of a resilient roller support, and
during a rotation of the blank, a set value of a level of pressure of application of the roller against the blank is made to vary between at least two non-zero values.

Thus the method enables the stitching pressure to be adapted to the angular speed of rotation of the blank. At low speed, the shape of the blank components and the general shape of the blank are preserved by providing a sufficiently low level of pressure. At high speed, a greater stitching pressure can be applied in order to ensure a high degree of stability of the stitching member regardless of the mechanical excitations generated by the irregularities of the laying support. The method according to the invention has the further advantage of enabling the stitching pressure to be increased at any time in order to treat a specific region, such as a shoulder region which conventionally requires a higher level of stitching pressure to ensure that the material is correctly joined to itself. Additionally, the resilient support allows the roller to follow the irregularities of the shape of the blank.

Preferably, a value of stiffness of the resilient support is made to vary during the rotation.

The variation in stiffness enables allowance to be made for the type of mechanical excitation to which the roller is subjected during stitching. This stiffness can therefore be increased during rotation at high speed in order to harden the application of the roller, while it can be reduced at low speed for softer application.

The value of stiffness is preferably made to vary in a monotonic way, while an angular rotation speed of the blank is made to vary in a monotonic way in the same direction as the stiffness.

This is because, at high rotation speeds, it is generally helpful to harden the application of the roller against the blank, while at low rotation speeds it is preferable to soften the application.

The set value is preferably varied in a continuous way.

The strength of the stitching pressure can therefore be adapted progressively as required, and particularly in accordance with the variation, which is also continuous, of the rotation speed of the blank.

Advantageously, the set value is made to vary in a monotonic way, while an angular rotation speed of the blank is made to vary in a monotonic way in the same direction as the set value.

For example, the set value is increased while an angular rotation speed of the blank is increased. Conversely, the set value may be reduced while an angular rotation speed of the blank is reduced.

The two variations are preferably proportional to each other, regardless of whether these values increase or decrease.

Advantageously, the set value is kept constant, preferably at least during a period in which an angular rotation speed of the blank is kept constant.

It is possible to make the set value higher during the stitching of one predetermined region of the blank than during the stitching of another region of the blank.

A computer program is also provided according to the invention, and comprises instructions in code capable of causing a method according to the invention to be executed when the program is run on a computer.

According to the invention, a device for producing a green tire blank is also provided, and includes:
a drum for supporting the blank,
at least one stitching member, comprising a roller and a resilient roller support, and
means capable of causing the drum to rotate and, during this rotation, causing a set value of a level of pressure of application of the roller against the blank to vary between at least two non-zero values.

The stitching member preferably includes an actuator capable of exerting a variable level of force, the resilient support being mounted in sequence with the actuator so as to receive the force and transmit it to the roller.

Thus the actuator enables stitching to be carried out at the set value chosen for the application pressure while the resilient support allows the roller to follow the irregularities of the shape of the blank.

The stiffness of the support is advantageously variable.

Thus, the resilient support can be hardened as desired, according to the stitching conditions, and in particular according to the rotation speed of the blank and therefore according to the type of excitation to which the roller is subjected.

The actuator can be made to be capable of modifying a stiffness, of the support.

Advantageously, the member is arranged in such a way that an increase in the set value, at least above a predetermined threshold, causes an increase in stiffness.

It is possible to make the stiffness of the support invariable.

In one embodiment, the support comprises at least one leaf spring.

Advantageously, the member comprises a wedge mounted movably along a face of the spring opposite the drum and bearing against a frame of the member.

This is a particularly simple means of modifying the stiffness of the support where a leaf spring is present.

In one embodiment, the support comprises at least one conical spring.

The support preferably comprises a plurality of springs, preferably having different stiffnesses, for at least one same roller.

Thus the choice of springs, their mounting and their stiffness enable the behaviour of the resilient support to be determined in a precise manner.

In one embodiment, the springs are leaf springs of different lengths and can bear on each other.

In another embodiment, the springs are conical springs.

The springs are advantageously mounted in sequence.

The device preferably comprises at least two rollers and respective independent resilient supports for the rollers.

Other characteristics and advantages of the invention will be made clear by the following description of a number of embodiments provided by way of non-limiting example, with reference to the attached drawings, in which:

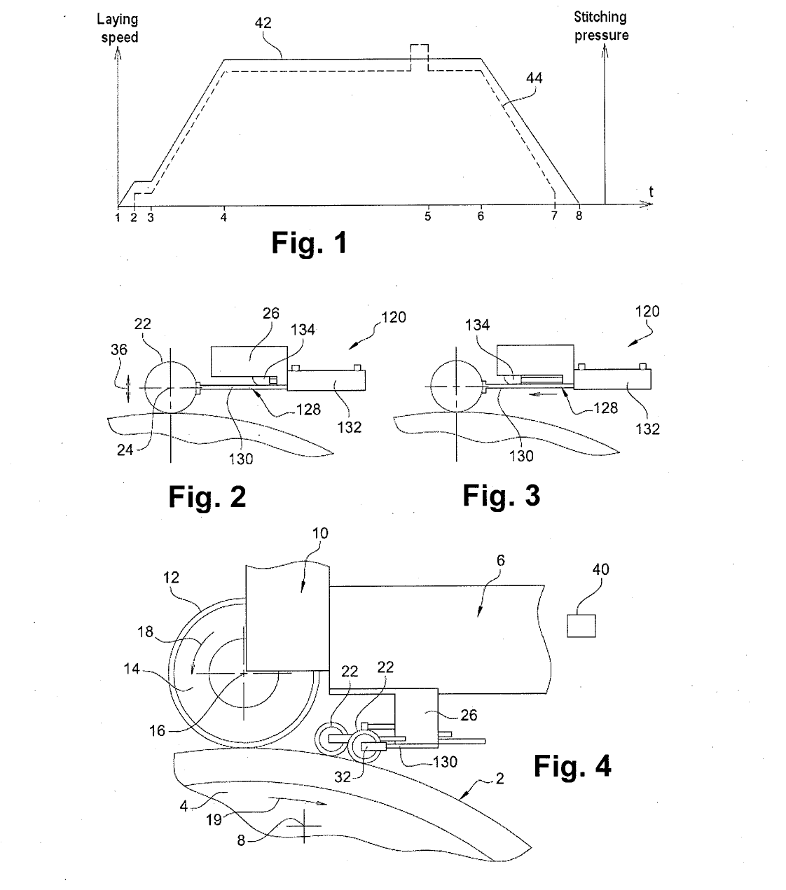

FIG. 1 is a diagram showing the variation with time of the blank rotation speed and the stitching pressure in one embodiment of the method according to the invention;

FIGS. 2 and 3 are two side views of a stitching member of a first embodiment of the device according to the invention;

FIG. 4 is a side view of the device incorporating the member of FIG. 2;

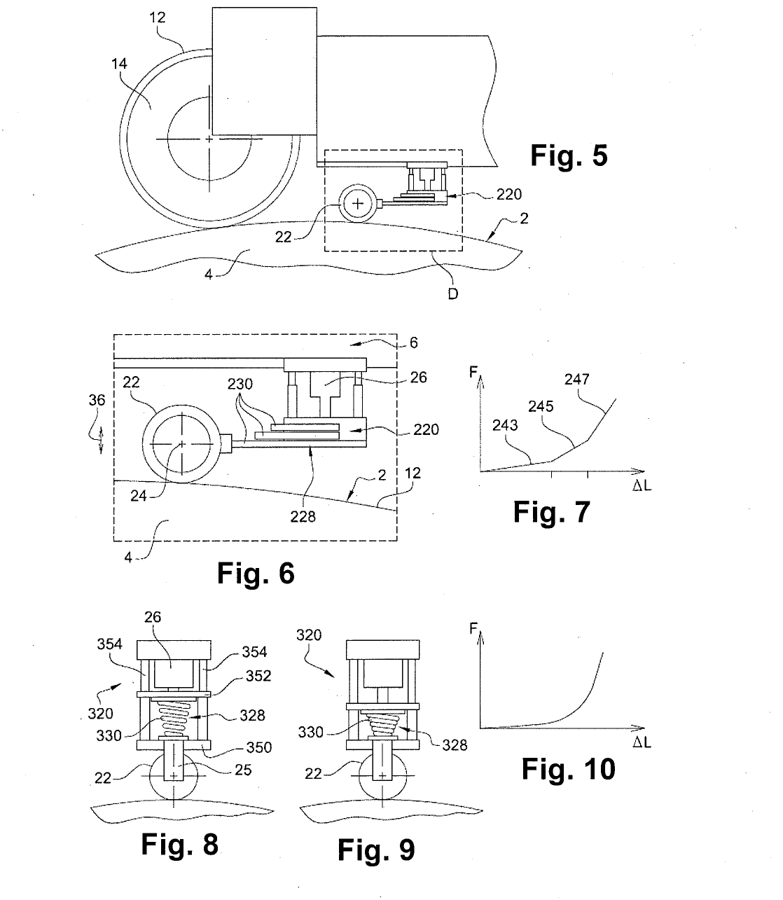

FIG. 5 is a view similar to that of the preceding figure, showing a second embodiment of the device;

FIG. 6 is a view on a larger scale of the detail D of the device of FIG. 5;

FIG. 7 is a diagram showing the variation of the strength of the return force of the resilient support as a function of the range of movement of the roller of the device of FIG. 6;

FIGS. 8 to 11 are views similar to those of FIGS. 2, 3, 7 and 5 respectively, showing a third embodiment of the device; and

FIGS. 12 to 14 are views similar to those of FIGS. 8 to 10 respectively, showing a fourth embodiment of the device.

### FIRST EMBODIMENT

A first embodiment of a device 6 for manufacturing a green blank of a vehicle tire according to the invention will now be described with reference to FIGS. 1 to 4.

The tires in question are intended for vehicles which may be private vehicles, light vehicles, utility vehicles, heavy goods vehicles or civil engineering vehicles.

The blank 2 is made by winding various components on to a drum 4 of the device 6. The following description will be mainly concerned with a step of winding a strip of green rubber 12 in a circumferential direction on to the blank supported by the drum, about an axis of rotation 8 of the latter. Different strips of this type are wound successively or simultaneously on to the blank in order to form at least one part of the latter. However, the invention is equally applicable to a blank production step other than that in which a strip is wound. The step may be concerned, for example, with placing a profile of the blank during only one revolution of the drum.

In the present case, the device 6 comprises an extrusion member 10 which receives a mixture of rubber in bulk at its upstream end, and produces at its downstream end a strip of rubber 12 on the peripheral face of a roll 14 of the extruder rotating about its axis 16 which is parallel to the axis 8 of the drum. In FIG. 4, the opposite directions of rotation of the nose 14 and of the drum 4 are indicated, respectively, by the arrows 18 and 19. The roll 14 is arranged in such a way that the strip 12 rotating with the roll is laid on to the blank 2 which is being produced, at the position in which the opposite faces of the blank simultaneously contact the roll 14 and the drum 4, and in which the roll applies the strip to the blank. The strip 12 is thus produced continuously and is wound continuously on to the blank 2 being manufactured.

The device 6 comprises members 120, shown in FIGS. 2 to 4, for stitching the blank in such a way that a predetermined pressure is exerted on the strip which has just been laid on to the blank. Each member 120 comprises, notably, a roller 22 which is applied against an outer face of the strip and extends downstream of the roll 14 relative to the direction of rotation 19 of the drum. The roller 22 forms a stitching element and is formed by a rigid body mounted movably in rotation about an axis 24 parallel to the axis 8.

In this case, there are three stitching members 120, placed in sequence in a direction parallel to the axis 8 which corresponds to the width of the blank. The member 120 located between the other two extends somewhat farther upstream than the other two. Of the latter members, one conceals the other in FIG. 4. The three stitching members 120 are independent of each other but are formed in the same way. One of them will now be described.

Each member 120 comprises an actuator 26 and a resilient support 28 mounted in sequence with the actuator relative to a frame of the device 6. Thus the actuator 26 exerts a force on the resilient support 28 which transmits this force to the roller, thereby causing it to exert a pressure on the blank.

The actuator 26 is of any type. It may be a pneumatic or hydraulic jack or an electric actuator such as a screw jack.

In the present case, the resilient support 28 comprises an elongate rectilinear flat leaf spring 130 which carries at its distal end a fork 32 in which the roller 22 is mounted rotatably about its axis 24. The spring 130 extends in a direction which is perpendicular to the axis 8 and which is inclined relative to the tangent to the blank at the point of contact of the roller with the latter. The leaf extends in a plane parallel to the axis 8. The proximal end of the spring 130 is rigidly fixed to the movable part of the actuator 26. The latter is also rigidly fixed to the body of a jack 132 which can cause a wedge 134 to slide in a direction parallel to the direction of the spring 130, the wedge remaining, throughout its movement, in contact with a face of the spring opposite the face turned towards the blank. During this movement, the wedge continues to bear in opposite directions on both the spring 130 and the actuator 26 between which it is sandwiched.

With reference to FIG. 2, when the wedge 134 is in its position closest to the body of the jack 132, which is the most retracted position, it bears against a region of the spring 130 which is relatively close to its proximal end. It therefore allows a range of resilient movement of the spring 130 in the direction 36 which is radial relative to the axis 8, or in a direction close thereto, over the greater part of the length of the spring, in other words over the whole portion of the spring between the wedge and the roller.

With reference to FIG. 3, if the wedge has been advanced by the jack 132 so as to approach the roller 120, the range of movement of the spring 130 is available only to the short portion of the spring extending between the roller and the wedge. This reduction in the length of the range of movement of the spring causes an increase in the resilient stiffness of its active part and consequently a hardening of the stitching member.

The device 6 comprises electronic and computerized control means 40 for controlling the execution of the steps of the method according to the invention, particularly those relating to the winding of the strip on to the blank. These means are, notably, capable of controlling the rotation speed of the drum 4 and the speed of extrusion of the strip 12. They can determine and control the way in which pressure is applied to the strip by the roller 22 acting against the blank for the stitching operation. They can also cause the set value of the level of the application pressure to vary, during a rotation of the blank, between at least two non-zero values, and can cause the sliding member to move.

The control of the speed of rotation of the drum, which corresponds to the speed of laying of the strip, and the control of the stitching pressure are illustrated, respectively, by solid and broken lines in the diagram of FIG. 1 relating to the vertical axes, the time being shown on the horizontal axis. The curve of speed 42 and the curve of pressure 44 are each continuous and formed by a broken line.

The step illustrated in this diagram starts at point 1 when the drum 4 is put into rotation as far as point 2. During this step, the speed increases proportionally to the time, while the stitching pressure remains zero, since the roller is not in contact with the blank.

During the next phase which starts at point 2, each stitching member 120 is put into contact with the strip. The pressure therefore increases vertically and then becomes stable, since the drum speed is also kept constant.

Subsequently, from point 3 onwards, the drum is constantly accelerated and the pressure is increased at the same time, in such a way that it also follows a rectilinear gradient. During this step, the set value is increased proportionally to the increase in angular speed.

At point 4, at the end of this step, the increase in rotation speed and pressure is also made to cease. From this point onwards, the drum has reached its maximum speed, and the winding and stitching of the strip continue, with the values of speed and pressure kept constant.

At point 5, without any change in speed, the stitching pressure is briefly increased until a plateau is reached, in order to exert force locally on a shoulder region. The pressure then returns to the value which it attained at point 4, until point 6 is reached. Throughout the interval between points 4 and 6, the laying speed is constant.

From point 6 onwards, the drum is constantly decelerated and the stitching pressure is also reduced, along a rectilinear gradient, until point 7 is reached. Thus the set value is reduced proportionally to the reduction in angular speed.

At this point, the roller 22 is moved away by means of the actuator 26 to separate it from the blank. Meanwhile the drum continues to rotate. This rotation is then interrupted at point 8.

It can be seen that the set value of the level of roller application pressure is made to vary in a continuous manner throughout the process from point 2 to point 7. It can also be seen that, in this case, the set value is increased in a monotonic way while the speed of the blank is increased in a monotonic way, in terms of both its angular rotation speed and its circumferential linear speed. The same applies to the reduction of the set value and the reduction of the speed.

The different set values of the level used during the process are determined experimentally in accordance with the form of the laid product, the material, its temperature, the speeds to be reached, the profiles to be formed on the tire, and the joining requirements at specific locations on the blank. It is particularly useful to specify:
the rotation speed of the drum when the roller is brought into contact,
the pressure of the roller immediately after making contact,
the set value of the pressure level for high rotation speeds,
the rotation speed of the drum when the roller is disengaged, and
the pressure of the roller immediately after disengagement.

These parameters can be validated by detecting the profile of the resulting accumulation. In some embodiments, it may be necessary to define intermediate points forming plateaux during the acceleration or deceleration of the drum.

In the present example, the speed of the drum varies in such a way that the peripheral linear speed of the blank changes from 0 to 1000 metres per minute. The set value of the roller application pressure changes from 0 to 10 decanewtons per millimetre relative to the width of the roller along the direction of its axis 24.

By using an actuator 26 other than a pneumatic or hydraulic jack it is possible to suppress the pumping effect which may appear with a fluid-operated jack.

During the step located between points 3 and 4 in which the rotation speed increases and the set value of the stitching pressure also increases, the means 40 also cause a progressive hardening of the resilient support 128. For this purpose, they cause the wedge 134 to be displaced so as to move from the position of FIG. 2 to that of FIG. 3. Thus, as the stitching pressure increases, the stitching member 120 becomes less flexible, making it more resistant to mechanical excitation.

The sliding member remains in the position of FIG. 3 during the steps completed from points 4 to 6. It then moves from the position of FIG. 3 to that of FIG. 2 as the drum is decelerated and as the pressure is reduced from point 6 to point 7.

The resilient support 128, the spring 130 and the path of the wedge 134 are designed so as to provide suitable stitching during all the above steps and in order to provide correct joining at point 5 where the stiffness of the spring 130 is at the maximum level.

The control means 40 comprise one or more programs in recorded form, capable of causing the execution of all or some of the steps of the blank manufacturing method as described. This program contains instructions in code for causing the execution of these steps when it is run in the means 40 which constitute a computer and comprise a microprocessor, a clock, a memory, and the like.

### SECOND EMBODIMENT

A second embodiment of the device 6 is illustrated in FIGS. 5 and 6. It differs from the preceding embodiment solely in the composition of the stitching member 220 and particularly that of the support 228. The other characteristics of the device and method, including those illustrated in FIG. 1, are similar to those of the first embodiment and will not be described again.

The jack 132 and the wedge 134 are absent. In this case, the resilient support 228 comprises, not a single spring, but a plurality of springs 230, numbering three in this case. In this case also, the three leaf springs have a flat elongate rectilinear shape. They are stacked on top of each other, parallel to each other. The three springs have different lengths, and are arranged in order of increasing length from top to bottom in the stack. The distal ends of the springs are retracted relative to each other. Thus the distal end of the second spring from the bottom extends to a point at a distance from the distal end of the lowest spring which carries the roller, and faces the latter spring. The distal end of the third spring, which is uppermost in the stack, is retracted relative to that of the second spring, and faces the latter.

During the winding of the strip and the stitching, the resilient support 228 allows free movement of the roller in the radial direction 36, as in the previous case. At a low drum rotation speed, while the roller application pressure is relatively low, the extent of the range of movement is also, usually, relatively small. It is therefore the lowest spring in the stack, which is also the longest, that makes the greatest contribution to the function of resilient support of the roller.

Starting from a first level of the stitching pressure set value, which in this case is simultaneous with the transition across a first threshold of the drum rotation speed, the pressure causes the lowest spring to come into contact with the spring immediately above it. In this case, these two springs, considered as a single spring, are largely responsible for the resilient support of the roller. The stiffness of this assembly is greater than the stiffness of the lowest spring used alone. The resilient support is therefore stiffer than in the preceding step.

Starting from a second level of the speed and of the set value of application pressure, the three springs come into contact with each other, imparting even greater stiffness to the resilient support.

Thus an increase in the set value of pressure, at least above a predetermined threshold, causes an increase in stiffness. This increase is, notably, produced by the actuator when the set value of the level of the application pressure increases.

However, if a specific mechanical excitation of the roller at low speed were to create an exceptionally large range of movement, the bearing of the springs on each other would also cause a temporary hardening of the support 220 as the roller moved away from the axis 8. Thus, FIG. 7 shows the variation of the force F exerted by the resilient support 228 on the strip as the range of movement ΔL in the direction 36 increases and as the springs progressively come to bear on each other. On the other hand, the force created by the actuator 26 is constant. Thus, in this continuous curve formed by a broken line, it is possible to distinguish a first rectilinear segment 243 characterizing the behaviour of the lowest spring acting alone, followed by a segment 245 with a steeper gradient corresponding to the two lowest springs bearing on each other, and finally a third segment 247 with an even steeper gradient, associated with the three springs bearing on each other.

### THIRD EMBODIMENT

A third embodiment of the device according to the invention will now be described, with reference to FIGS. 8 to 11.

In this embodiment, the member 320 comprises a frame 350 of fixed length enclosing the actuator 26 and a single spring 330. This spring is a conical spring.

The actuator 26 and the spring 330 are mounted in sequence and aligned with one following the other. In this case, the direction of alignment of the actuator and the spring is radial relative to the axis 8. However, it would be possible to arrange for this direction to be inclined relative to the radial direction.

The body of the actuator 26 bears with its proximal end against the proximal end of the frame 350. The movable part of the actuator forming its distal end bears against a movable plate 352 guided slidably along the frame by means of uprights 354 of the latter. A proximal end of the spring 350 bears against a face of the plate opposite that on which the actuator 26 bears. The roller 22 is mounted movably in rotation in a fork 25 carried by the distal end of the spring. The distal end of the spring only bears on the frame if the roller either makes no contact with the blank or exerts insufficient pressure. At rest, the actuator and spring bear on the frame along the same alignment and in opposite directions.

The control means 40 cause the actuator 26 to generate a thrust in the radial direction corresponding to the desired set value of the application pressure of the roller 22 on the strip and blank. The force of the actuator is transmitted to the plate 352, which transmits it to the proximal end of the spring 330. Since the latter is in static equilibrium, the same force is exerted by the spring on the roller 22, which exerts a pressure on the blank.

If the rotation speed is low and the set value of the pressure level is also low, the member 320 is in the configuration shown in FIG. 8, but the distal end of the spring does not bear on the frame. As the level of the force exerted by the actuator 26 is low, the length of the spring 330 is relatively large. The range of movement of the roller is therefore large.

If the rotation speed is high and the set value of the stitching pressure level is also high, the actuator 26 strongly compresses the spring 330. Since the turns are almost abutting, or in other words almost bear on each other in the direction of the range of movement, the range of movement available to the spring is small. The stiffness of the resilient support 328 is that of the spring, and is therefore unchanged.

Subsequently, if the thrust of the actuator is very large, the turns begin abutting, but the spring does not yet bear against the frame 350. In this case, the resilience of the member 320 is provided only by the actuator 26 itself.

In this third embodiment, the resilient support 328 itself has a fixed stiffness.

FIG. 10 illustrates the variation of the force F exerted by the resilient support 328 on the strip as the range of movement ΔL in the direction 36 increases. A quasi-rectilinear step, strongly inclined relative to the vertical axis, in which the turns are not abutting, follows a strongly inclined, or even near-vertical, quasi-rectilinear step in which the turns are abutting.

In this case, the actuator 26 is made in the form of a diaphragm cylinder.

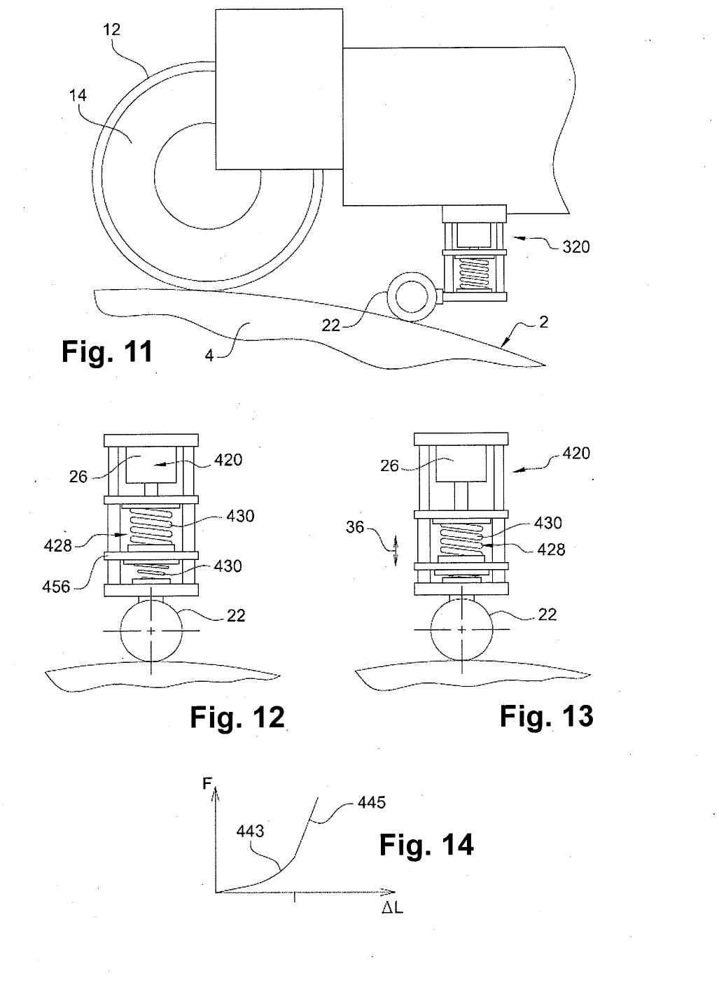

FIG. 11 shows a variant mounting of the roller on the member 320, with the roller in an offset position.

### FOURTH EMBODIMENT

A fourth embodiment of the device according to the invention is shown in FIGS. 12 to 13. This is a simple variant of the third embodiment. It differs from the latter solely in that the resilient support 428 comprises two springs 430 having different stiffnesses, instead of one spring. The two springs and the actuator 26 are mounted in sequence. The spring 430 having the greater stiffness is located between the other spring and the actuator. In this case, this spring is cylindrical, while the other spring is conical. The distal end of one of the springs bears against a plate 456, against the opposite side of which the proximal end of the other spring bears.

In this fourth embodiment, the resilient support 428 has a variable stiffness.

FIG. 12 shows the situation in which the actuator 26 exerts a moderate force on the roller. Neither of the springs has abutting turns. The range of movement of the roller in the radial direction is therefore large and is provided primarily by the spring with less stiffness.

In the situation shown in FIG. 13, the force exerted by the actuator is such that the spring with less stiffness is compressed, with its turns abutting each other. The range of movement of the roller is therefore provided only by the resilience of the spring with high stiffness. The stiffness of the resilient support assembly 428 is therefore increased.

In this case also, the rigidity of the resilient support 428 increases when the pressure exerted by the actuator 26 increases.

Thus, FIG. 14 illustrates the variation of the force F exerted by the resilient support 428 on the strip as the range of movement ΔL in the direction 36 increases under the effect of irregularities of the blank, while the force generated by the actuator 26 is constant. On this continuous curve formed by a broken line, it is possible to distinguish a first portion of curve 443 characterizing the behaviour of the two springs combined, followed by a rectilinear segment 445 with a steeper gradient corresponding to the stiffer spring only.

It is possible to cause the turns of the stiffer spring to be in contact with each other, above a certain level of force applied by the actuator 26, so that the support 428 ceases to have any resilience in itself.

This embodiment makes it possible to have a wide range of variation of pressure and to choose the strength of the stitching pressure with greater precision, notably at low speed. This is because, for a given displacement of the actuator, the variation of force is smaller at low pressure.

Clearly, numerous modifications can be made to the invention without departure from the scope of the invention.

It is possible to make the stitching member independent of the device for feeding the strip on to the drum.

1. A method for producing a green tire blank, wherein:
at least one stitching roller is applied to the blank with the use of a resilient roller support; and
during a rotation of the blank, a set value of a level of pressure of application of the roller against the blank is made to vary between at least two non-zero values.

2. The method according to claim 1, wherein a value of stiffness of the resilient support is made to vary during the rotation.

3. The method according to claim 2, wherein the value of stiffness is made to vary in a monotonic way, while an angular rotation speed of the blank is made to vary in a monotonic way in the same direction as the stiffness.

4. The method according to claim 1, wherein the set value is made to vary in a monotonic way, while an angular rotation speed of the blank is made to vary in a monotonic way in the same direction as the set value.

5. The method according to claim 1, wherein at the set value is caused to be higher during the stitching of one predetermined region of the blank than during the stitching of another region of the blank.

6. A device for producing a green tire blank comprising:
a drum for supporting the blank;
at least one stitching member, comprising a roller and a resilient roller support, and
means capable of causing the drum to rotate and, during this rotation, causing a set value of a level of pressure of application of the roller against the blank to vary between at least two non-zero values.

7. The device according to claim 6, wherein the stitching member includes an actuator capable of exerting a variable level of force, the resilient support being mounted in sequence with the actuator so as to receive the force and transmit it to the roller.

8. The device according to claim 6, wherein the support has a variable stiffness.

9. The device according to claim 6, wherein the actuator is capable of modifying a stiffness of the support.

10. The device according to claim 8, wherein the member is arranged in such a way that an increase in the set value, at least above a predetermined threshold, causes an increase in stiffness.

11. The device according to claim 6, wherein the support comprises at least one leaf spring.

12. The device according to claim 11, wherein the member comprises a wedge mounted movably along a face of the spring opposite the drum and bearing against a frame of the member.

13. The device according to claim 6, wherein the support comprises at least one conical spring.

14. The device according to claim 6, wherein the support comprises a plurality of springs, for at least one same roller.

15. The device according to claim 14, wherein the springs are mounted in sequence.

16. The device according to claim 14, wherein the springs have different stiffnesses.

17. The device according to claim 14, wherein the springs are conical springs.

18. The method according to claim 4, wherein the two variations are proportional to each other.
